(19) United States
(12) Patent Application Publication
(10) Pub. No.: US 2026/0194002 A1
(43) Pub. Date: Jul. 9, 2026

(54) MODULAR SUPERCHARGER ADAPTER SYSTEM FOR AUTOMOTIVE APPLICATIONS

(71) Applicants: Stacy Gifford, Brownwood, TX (US); Gregory Cole Black, Abilene, TX (US)

(72) Inventors: Stacy Gifford, Brownwood, TX (US); Gregory Cole Black, Abilene, TX (US)

(21) Appl. No.: 19/440,100

(22) Filed: Jan. 5, 2026

Related U.S. Application Data
(60) Provisional application No. 63/742,336, filed on Jan. 6, 2025.

(51) Int. Cl. F02B 67/10

(52) U.S. Cl. CPC F02B 67/10

(57) ABSTRACT

A modular supercharger adapter system for automotive engine platforms includes a lower manifold adapter configured to interface between a supercharger assembly and an engine component. The lower manifold adapter includes a cast body defining a plenum volume and an engine-side interface region machinable to form platform-specific fitment features. The cast body is common across multiple engine platforms. The system includes an adapter plate with a rectangular fastener pattern to mount the supercharger assembly to the lower manifold adapter, providing attachment for the supercharger assembly, intercooler, or upper manifold. The system includes a modular pulley and hub assembly to transfer rotational power from an engine crankshaft to a supercharger input shaft, with an interchangeable hub selectable to accommodate different supercharger shaft configurations.

### CROSS-REFERENCE TO RELATED APPLICATIONS

This application claims the benefit of U.S. Provisional Ser. No. 63/742,336, titled “Modular Supercharger Adapter System for Automotive Applications,” filed Jan. 6, 2025, which is hereby incorporated by reference in its entirety.

### TECHNICAL FIELD

The present disclosure relates to automotive supercharger retrofit systems, and more particularly to a modular adapter system for retrofitting original equipment manufacturer (“OEM”) superchargers onto various engine platforms.

### BACKGROUND

Superchargers have been utilized in automotive applications to increase engine performance by forcing additional air into the combustion chambers beyond what would naturally be drawn during the intake stroke. By compressing the intake air, superchargers enable engines to produce greater power output from a given displacement. Various types of superchargers exist, including Roots-type, twin-screw, and centrifugal designs, each offering different performance characteristics.

The automotive aftermarket industry has developed supercharger retrofit systems to allow vehicle owners to add forced induction to engines that were not originally equipped with superchargers. Mounting hardware and adapters are required to integrate a supercharger with an existing engine platform. Existing supercharger retrofit systems in the aftermarket tend to be designed for specific vehicle and engine combinations. Such vehicle-specific systems require custom lower intake manifolds, dedicated mounting brackets, and purpose-built adapter components that are tailored to a particular engine platform and supercharger model. The development and manufacturing of these dedicated components for each vehicle application can result in elevated costs and limited availability across different engine platforms. The variety of engine configurations, cylinder head port arrangements, and supercharger mounting patterns across different manufacturers and model years presents challenges for developing broadly compatible adapter systems.

Belt-driven superchargers require pulley systems to transfer rotational power from the engine crankshaft to the supercharger input shaft. Different supercharger models may have varying shaft configurations, and different engine installations may present different belt routing requirements and spacing constraints. Accommodating these variations while maintaining proper belt alignment and tension can complicate the design of universal retrofit systems.

Throttle body interfaces between supercharger outlets and intake ducting represent another area where compatibility challenges arise. Different supercharger models feature varying outlet configurations, and adapting these to standardized throttle body sizes or intake ducting require custom transition pieces. The materials and manufacturing methods used for such adapters can affect weight, thermal characteristics, and production costs.

Accordingly, there exists a general interest in supercharger adapter systems that can provide compatibility across multiple engine platforms and supercharger models while utilizing manufacturing approaches that support cost-effective production.

### BRIEF DESCRIPTION OF FIGURES

FIG. 1A depicts a front orthogonal view of a modular supercharger adapter system in an exploded arrangement, according to some embodiments.

FIG. 1B depicts a side orthogonal view of a modular supercharger adapter system in an exploded arrangement, according to some embodiments.

FIG. 1C depicts an isometric exploded view of a modular supercharger adapter system showing spatial relationships between components, according to some embodiments.

FIG. 2A depicts an isometric view of a lower manifold adapter for a modular supercharger adapter system, according to some embodiments.

FIG. 2B depicts a front orthogonal view of a lower manifold adapter, according to some embodiments.

FIG. 2C depicts a side orthogonal view of a lower manifold adapter, according to some embodiments.

FIG. 2D depicts a top plan view of a lower manifold adapter, according to some embodiments.

FIG. 2E depicts an isometric view of a lower manifold adapter from a different angle, according to some embodiments.

FIG. 3 depicts a flowchart for a method of manufacturing a lower manifold adapter, according to some embodiments.

FIG. 4A depicts a casting pattern in the manufacturing process of a mold for the lower manifold adapter, according to some embodiments.

FIG. 4B depicts an isometric view of a lower manifold adapter, according to some embodiments.

FIG. 4C depicts multiple perspective views of a lower manifold adapter component, according to some embodiments.

FIG. 4D depicts isometric views of a lower manifold adapter positioned within a manufacturing fixture, according to some embodiments.

FIG. 4E depicts a top-down orthogonal view of a lower manifold adapter assembly, according to some embodiments.

FIG. 5 depicts an isometric view of adapter plates configured for various engine platforms, according to some embodiments.

FIG. 6A depicts an isometric view of adapter plates configured for different supercharger models, according to some embodiments.

FIG. 6B depicts a top plan view of adapter plates configured for different supercharger models, according to some embodiments.

FIG. 7 depicts multiple views of a modular pulley and hub assembly for a supercharger retrofit system, according to some embodiments.

FIG. 8 depicts an isometric exploded view of throttle body adapters configured for different supercharger models, according to some embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present modular supercharger adapter system provides a single, unibody, common cast lower manifold adapter that defines a plenum volume and incorporates a machinable engine-side interface region formed as a substantially rectangular interface. In contrast to prior approaches that rely on platform-specific casting tooling or fully CNC-machined components unique to each engine family, the platform fitment described herein can be achieved by machining the engine-side region (e.g., openings, bolt patterns, and sealing features) while leaving the cast plenum/body substantially common across different engine and supercharger platforms. This architecture provides numerous benefits. For example, it reduces upfront tooling cost, per-platform engineering time, and production lead time relative to bespoke lower-manifold solutions.

Unlike plenum adapters that do not integrate meaningful plenum volume—often forcing the use of spacers before a supercharger can be packaged effectively—the common unibody lower-manifold adapter described herein integrates the plenum by design. Spacers are therefore optional for volume tuning rather than required for basic function, and the primary airflow path is kept below the supercharger mounting plane to preserve a low-profile stack for supercharger/intercooler packaging. Keeping the plenum contained within the casting of the lower manifold adapter stabilizes geometry across platforms, promotes consistent airflow characteristics and simplifies calibration and baselining.

The lower manifold adapter blank can be formed using an aluminum casting process. The aluminum construction of the lower manifold adapter provides numerous benefits, including lower weight which may contribute to overall vehicle weight reduction and in turn improves vehicle performance. The aluminum material also provides improved thermal conductivity which may help dissipate heat from the intake air stream and maintain optimal intake air temperatures during operation. The casting manufacturing process for the lower manifold adapter offers scalability and design flexibility compared to sheet metal fabrication processes. Design modifications may be implemented by updating casting patterns or molds. The manufacturing process may enable production of lower manifold adapters in varying quantities, from prototype quantities to production volumes, using established aluminum casting processes and equipment.

Manufacturing of the lower manifold adapter can include two or more primary machining operations performed on the lower manifold adapter blank. In some embodiments, a first operation machines the bottom rectangular surface flat to establish a planar reference surface, and a second operation machines the opposite face to define platform-specific engine fitment features, including at least the cylinder openings, engine bolt pattern, and sealing surface. In some embodiments, the first and second operations can be performed in reverse order for flexibility. Because the blank lower manifold adapter prior to machining is uniform across different engine and supercharger platforms, a common fixture can be used for repeatable positioning to perform the first and second operations, enabling batch production in a single setup and reducing changeover complexity as new platforms are introduced. This process preserves billet-like flexibility in fitment while achieving casting-level economics for the primary geometry.

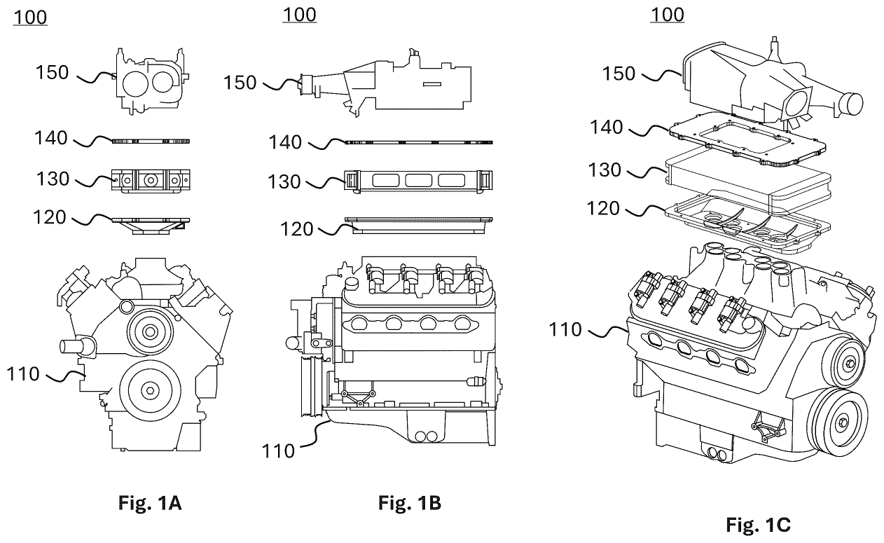

To provide context for the detailed description of the modular supercharger adapter system, the following provides an overview of the system architecture and its components. Referring to FIGS. 1A-1C, a modular supercharger adapter system 100 for automotive engine platforms is illustrated in multiple views. FIG. 1A provides a front orthogonal view showing individual components in an exploded arrangement. FIG. 1B provides a side orthogonal view of the same exploded arrangement. FIG. 1C provides an isometric exploded view showing spatial relationships between components of the modular supercharger adapter system 100.

The modular supercharger adapter system 100 includes several components arranged in a stacked configuration. At the base of the assembly is an engine block 110, which serves as a foundation for mounting the remaining components. The engine block 110 may be a V-configuration engine with cylinder heads, intake ports, and accessory mounting locations on a top face or an inline configuration with a side face. The engine block 110 may correspond to any of a plurality of engine platforms, including Ford engine platforms, Toyota engine platforms, Nissan engine platforms, and Mitsubishi engine platforms, among others.

With continued reference to FIGS. 1A-1C, a lower manifold adapter 120 is positioned above the engine block 110. The lower manifold adapter 120 is configured to interface between the engine block 110 and upper components of the modular supercharger adapter system 100. The lower manifold adapter 120 may include an engine-side interface region such as a bottom flange that mates with cylinder heads or a factory lower intake manifold of the engine block 110. The lower manifold adapter 120 may be manufactured by casting, with platform-specific fitment features machined into the bottom flange in the lower manifold adapter 120.

An air charge cooler 130 may be positioned above the lower manifold adapter 120. The air charge cooler 130 is an optional component of the modular supercharger adapter system 100. In some cases, the air charge cooler 130 includes a rectangular housing with internal passages for cooling compressed air charge before the compressed air charge enters the engine block 110. The air charge cooler 130 may reduce intake air temperatures, which may improve engine performance.

As further shown in FIGS. 1A-1C, an adapter plate 140 is positioned above the air charge cooler 130. The adapter plate 140 may be manufactured from aluminum. The adapter plate 140 provides a mounting interface between the lower manifold adapter 120 (or optionally air charge cooler 130) and a supercharger assembly 150. In some cases, the adapter plate 140 is manufactured using CNC laser cutting for precision and cost-efficiency. The adapter plate 140 may include mounting features arranged to accommodate different supercharger models.

The supercharger assembly 150 is positioned at the top of the modular supercharger adapter system 100. The supercharger assembly 150 may include a housing containing a supercharger mechanism and an output shaft connection for a drive pulley system. The supercharger assembly 150 may be any of a plurality of aftermarket or OEM supercharger models, including Eaton M90, Eaton M112, Ford GT500 superchargers, Roush superchargers, Ford Performance superchargers, and Land Rover/Jaguar TVS superchargers, among others.

The modular stacked configuration of the modular supercharger adapter system 100 enables compatibility with multiple engine platforms and supercharger models. By providing interchangeable components, the modular supercharger adapter system 100 allows retrofitting of OEM or customized superchargers onto a wide range of engine platforms without requiring platform-specific casting tooling or complete system replacement. In some cases, changing a single component of the modular supercharger adapter system 100 enables adaptation to a different engine platform or supercharger model.

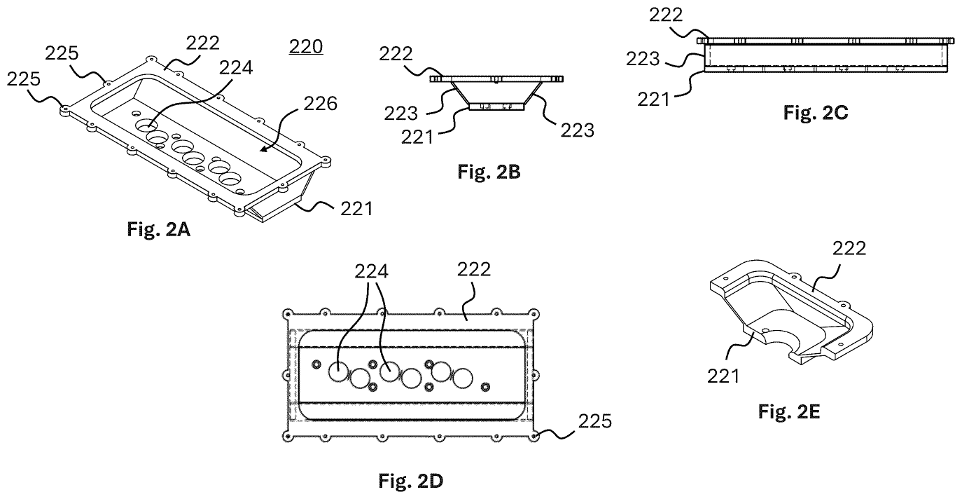

Referring to FIGS. 2A-2E, a lower manifold adapter 220 for the modular supercharger adapter system 100 is illustrated in multiple views. FIG. 2A provides an isometric view of the lower manifold adapter 220, showing the overall three-dimensional configuration of the component. The lower manifold adapter may be configured to interface between the supercharger assembly and an engine component, which may be a cylinder head or a factory lower intake manifold depending on the application. The lower manifold adapter 220 may be manufactured as a cast component, with platform-specific features machined into engine-facing and supercharger-facing interface regions of the lower manifold adapter 220. The lower manifold adapter may include a bottom flange that is machinable to fit a plurality of different OEM lower manifolds. This configurability allows the lower manifold adapter to accommodate various engine platforms without requiring entirely different adapter components for each application. In some embodiments, the lower manifold adapter may be manufactured by aluminum casting, which may be suitable for certain applications or production volumes. When manufactured by aluminum casting, the lower manifold adapter may be produced using sand casting, investment casting, or die casting processes. Sand casting may be utilized for prototype development or low-volume production runs, providing flexibility in design modifications and relatively low tooling costs. Investment casting may be employed when precise dimensional tolerances and smooth surface finishes are required, particularly for complex internal geometries or intricate port configurations. Die casting may be selected for high-volume production applications where dimensional consistency and rapid production cycles are priorities. In some embodiments, the lower manifold adapter may be manufactured by cutting from a flat sheet material, with multiple parts nested together for material efficiency. This nested arrangement may reduce material waste during manufacturing and may contribute to cost-effective production.

The lower manifold adapter 220 includes a bottom flange 221 configured to interface with an engine component. The bottom flange 221 may mate with cylinder heads or intake manifold of an engine assembly. For example, in some embodiments, the bottom flange 221 may interface with a factory lower intake manifold, depending on the application. The bottom flange 221 can include multiple openings where each one of the openings is aligned with a cylinder head of the engine assembly. The bottom flange 221 also includes bolt patterns for securing the lower manifold adapter 220 to the engine assembly. The bottom flange 221 may be machined to fit a wide range of OEM lower manifolds, enabling adaptation to multiple engine platforms without requiring platform-specific casting tooling.

As shown in FIGS. 2B-2D, the bottom flange 221 has dimensional characteristics including a length L₁ and a width W₁. In some embodiments, length L₁ can be in a range between about 60 mm to about 200 mm. In some embodiments, width W₁ can be in a range between about 250 mm and about 450 mm. In some embodiments, a ratio of width W₁ over length L₁ can in a range between about 5:1 and about 2:1. The engine-facing bottom flange of the lower manifold adapter is formed as a generally rectangular, and its width and length are selected to encompass the bolt patterns and sealing footprints used by most engine platforms. By providing excess dimension in both lateral and longitudinal directions relative to typical manifold interfaces, the flange can be locally machined to define platform-specific features (e.g., bolt arrays, sealing lands, and optional port-matching) without altering the common casting or compromising structural rigidity, sealing margins, or tool access. The bottom flange 221 works in concert with the two-step machining process in which a planar datum is established on the bottom flange and supercharger-specific features are cut on the opposite face using a common fixture, ensuring repeatable location, broad pattern coverage, and batch efficiency across a wide range of engines. In practice, the majority of platforms are supported within the as-cast flange area, thereby minimizing new tooling, reducing per-platform engineering time, and preserving the lower manifold adapter's universal applicability.

With continued reference to FIGS. 2A-2E, a top flange 222 is formed at an upper portion of the lower manifold adapter 220. The top flange 222 provides a mounting surface for attachment of upper components of the modular supercharger adapter system 100. For example, the top flange 222 is configured to receive the adapter plate 140 for mounting the supercharger assembly 150 or an optional air charge cooler 130. As shown in FIG. 2D, the top flange 222 has dimensional characteristics including a length L₂ and a width W₂. In some embodiments, length L₂ can be in a range between about 150 mm and about 300 mm. In some embodiments, width W₂ can be in a range between about 300 mm and about 650 mm. In some embodiments, a ratio of width W₂ over length L₂ can in a range between about 5:1and about 2:1. In some embodiments, the top flange 222 encompasses a greater lateral surface area than the bottom flange 221. For example, the lateral surface area A₂ of upper flange 222 (i.e., W₂ multiplied by L₂) is greater than the lateral surface area A₁ of bottom flange 221 (i.e., W₁ multiplied by L₁). In some embodiments, lateral surface area A₂ can be greater than lateral surface area A₁. In some embodiments, the surface area ratios A₁/A₂ can be in a range between 0.9:1 and 4:1. The supercharger-facing upper flange of the lower manifold adapter is configured as a broad, generally rectangular mounting face sized to accommodate an adapter plate. Its width and length are selected to support the rectangular bolt patterns used across adapter plates that mate with superchargers, intercoolers, and upper manifolds, allowing the same casting to accept different upper components without retooling or billet machining. By establishing the generous upper envelope of the top flange 222 and using a rectangular array that may be proprietary or conform to an industry-standard pattern that is implemented on the adapter plate, the system enables adapter plates to be produced and iterated independently of engine platform selection, while maintaining a low-profile interface that avoids protruding airflow features and reduces reliance on height-adding spacers. In practice, this configuration covers the bolt-pattern footprints required by most upper-component families, with optional spacers employed only for volume tuning rather than basic fitment, thereby simplifying stocking, shortening lead times, and preserving the casting's universal applicability.

Side walls 223 extend between the bottom flange 221 and the top flange 222. The side walls 223 and the top and bottom flanges define a casting body that provides a plenum volume 226 within the lower manifold adapter 220. The plenum volume contains trapezoidal cross-sectional areas as depicted in FIG. 2B. In some embodiments, two of the side walls can be substantially non-vertical (e.g., the side walls 223 shown in FIG. 2B) and two of the side walls can be substantially vertical (e.g., the side walls 223 shown in FIG. 2C). In some embodiments, the plenum volume is surrounded by all non-vertical side walls and the cross-sectional areas shown in both FIGS. 2B and 2C would have trapezoidal shapes. In some embodiments, the side walls can have different angles with respect to the top or bottom flanges such that the cross-sectional area is a scalene trapezoidal shape. For example, the two side walls 223 shown in FIG. 2B can have different angles with respect to bottom flange 221. In some embodiments, the two side walls 223 shown in FIG. 2C can also have different angles with respect to bottom flange 221. Various side-wall angles can be customized to accommodate different engine and supercharger placements. However, a symmetrical configuration for side walls 223 can improve manufacturing efficiency and is broadly compatible with a wide range of engine and supercharger configurations. Both cross-sectional structures in FIGS. 2B and 2C may be isosceles trapezoids, or the isosceles trapezoidal shape may apply to only one of them.

The plenum volume 226 provides an internal chamber for airflow between the supercharger assembly 150 and intake ports of the engine block 110. The plenum volume can function as an air reservoir to stabilize intake charge delivery by attenuating transient pressure fluctuations. The present application describes a plenum volume that can include a single, common chamber located directly downstream of the supercharger and upstream of the engine intake, and this direct interposition of a single chamber contributes to several benefits. For example, increasing the plenum size inhibits charge-air temperature rise downstream of the supercharger and increases the mass of intake air stored and available for cylinder filling, thereby providing a larger breathing buffer for the engine. By increasing the available compressible volume, the plenum promotes smoother and more uniform mass airflow to each cylinder, thereby improving cylinder-to-cylinder distribution and reducing pressure pulsation amplitude. The resultant pressure stabilization enhances engine performance and fuel conversion efficiency, particularly within low-to mid-range engine speeds, by maintaining a more consistent intake manifold absolute pressure, moderated charge temperature, and stable charge density under varying load and throttle conditions. In some embodiments, the plenum volume is formed via a casting process that provides the enlarged plenum volume with minimal additional material usage and without significant increase in manufacturing cost.

Height H represents the vertical separation between bottom flange 221 and top flange 222. If the lateral dimensions of the bottom flange 221 and the top flange 222 are held constant, increasing the height H renders the side walls more vertical, thereby increasing the plenum volume. Therefore, height H and the profile of the side walls 223 can be chosen for a nominal amount of plenum volume. For example, a greater height H can provide a greater plenum volume while a lower height can provide a flatter mounting interface and may facilitate a low-clearance supercharger and intercooler packaging.

As further shown in FIGS. 2A and 2D, multiple openings 224 are formed in the bottom flange 221. The openings 224 allow air passage from the plenum volume 226 into the cylinder heads or air intake manifold of the engine assembly. The openings 224 may be arranged to correspond with cylinder intake port locations of the engine block 110.

An adapter bolt pattern 225 is arranged around a perimeter of the top flange 222. The adapter bolt pattern 225 provides mounting locations for securing the lower manifold adapter 220 to the adapter plate 140 or the supercharger assembly 150. As shown in FIG. 2D, the adapter bolt pattern 225 may be distributed around the perimeter of the top flange 222. The adapter bolt pattern 225 may be a rectangular array that corresponds to a proprietary fastener pattern or an industry-standard fastener pattern, enabling compatibility with multiple upper components.

Referring to FIG. 2E, an isometric view from a different angle shows the bottom flange 221 and the top flange 222 of the lower manifold adapter 220, illustrating the internal configuration and the relationship between the flanges. The configuration of the lower manifold adapter 220 allows adaptation to both cylinder head interfaces and factory manifold interfaces. By machining the bottom flange 221 to match a selected engine platform, the lower manifold adapter 220 may be adapted to a wide range of engine configurations while maintaining a cast body. In some cases, the lower manifold adapter 220 may interface directly with intake ports of the cylinder when a factory upper manifold is removed. In other cases, the lower manifold adapter 220 may interface with a factory lower intake manifold, depending on the engine platform and installation requirements.

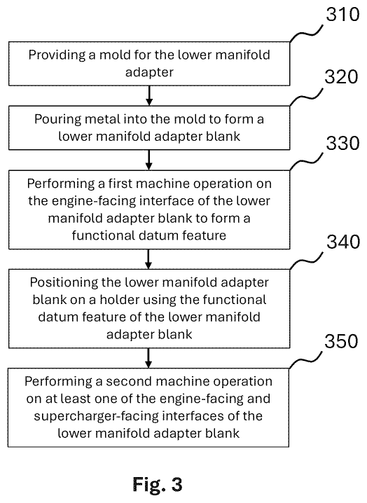

Referring to FIG. 3, a flowchart for a method of manufacturing the lower manifold adapter 220 is illustrated. The method includes operations that utilize casting followed by multiple machining operations, with a first machining operation creating functional datum feature on a bottom surface that enables proper positioning for a second machining operation and is configured to be coupled to an engine component. The aluminum casting approach may offer advantages in terms of material properties and design flexibility. For example, cast aluminum may provide superior strength-to-weight ratios and is less costly compared to fabricated sheet metal alternatives. The casting process may also enable the incorporation of complex internal geometries, reinforcing ribs, and integrated mounting features that may be difficult or costly to achieve through other manufacturing methods.

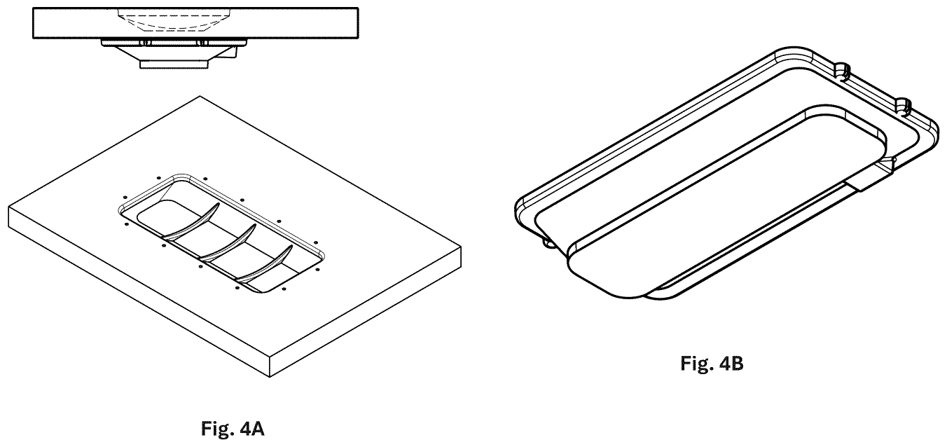

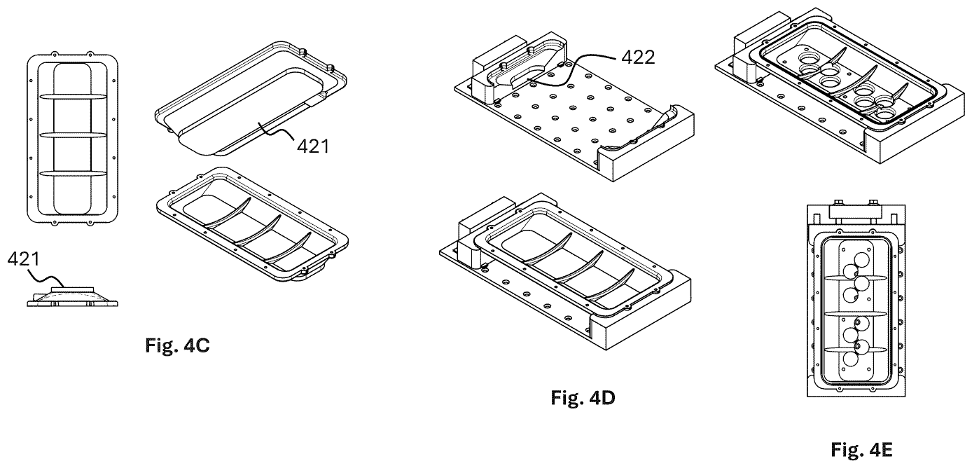

Operation 310 involves providing a mold for the lower manifold adapter 220, according to some embodiments. FIG. 4A provides a side view (upper figure) and an isometric view (lower) of an exemplary casting that forms the mold used in operation 310. In some embodiments, the casting is a sand-casting pattern. The mold may be configured to produce a cast lower manifold blank that defines the plenum volume 226 contained within a cast body. The mold may include features that form an engine-side machinable interface region that is generally rectangular. In some cases, the mold may be a reusable mold configured for batch production of multiple cast lower manifold blanks. The aluminum casting process may begin with the creation of a pattern or mold corresponding to the desired lower manifold adapter geometry. For example, the mold can be designed using CAD software and produced using 3D printing technology. For sand casting applications, the pattern may be used to create a sand mold cavity into which molten aluminum is poured. The aluminum alloy selected for casting may be chosen based on the specific requirements of the application, such as A356 aluminum alloy for applications requiring good castability and mechanical properties, or A380 aluminum alloy for die casting applications requiring dimensional stability.

Operation 320 involves pouring metal into the mold to form a lower manifold adapter blank, according to some embodiments. An example of the formed lower manifold blank produced in operation 320 is depicted in FIG. 4B. The metal may be aluminum or another suitable material for automotive applications. The casting process produces a semi-finished component that includes the plenum volume 226 and interface regions that may be subsequently machined to achieve platform-specific fitment. Additional treatments may be applied. For example, heat treatment processes may be applied to cast aluminum lower manifold adapters to enhance mechanical properties. Solution heat treatment followed by artificial aging may be employed to achieve desired strength and hardness characteristics. The heat treatment process may also relieve casting stresses and improve dimensional stability. Surface finishing operations may include shot blasting or tumbling to remove casting scale and improve surface texture. Anodizing or other protective coatings may be applied to enhance corrosion resistance and provide a uniform appearance.

Operation 330 involves performing a first machine operation on an engine-facing interface of the lower manifold adapter blank to form a functional datum feature. An example of a functional datum feature formed in operation 330 is the functional datum feature 421 depicted in FIG. 4C. The first machine operation may include machining a first face of the generally rectangular engine-side machinable interface region to form a planar reference surface. The planar reference surface provides a datum for subsequent machining operations and enables repeatable positioning of the lower manifold adapter blank. The first machine operation may include, for example, a milling process that produces a substantially rectangular flat surface with predetermined dimensions that are uniform across different engine components and supercharger components to improve manufacturing efficiency and lower costs. A machining program corresponding to the specific supercharger platform may be selected and executed during the first machine operation.

Operation 340 involves positioning the lower manifold adapter blank on a holder using the top flange 222 of the lower manifold adapter blank, according to some embodiments. An example of positioning the lower manifold adapter on a holder in operation 340 is depicted in FIG. 4D. The holder may be a recessed fixture such as grooves 422 configured to locate functional datum 421 of the lower manifold adapter blank in a repeatable position independent of a selected engine platform. In some cases, the fixture may be configured to hold multiple cast lower manifold blanks such that machining operations may be performed on the multiple cast lower manifold blanks in a single setup. The positioning step prepares the lower manifold adapter blank for subsequent machining by establishing a consistent reference orientation.

Operation 350 involves performing a second machine operation on an engine-facing interface of the lower manifold adapter blank, according to some embodiments. An example of the formed bottom flange 221 produced in operation 350 is depicted in FIG. 4E. The second machine operation may include machining platform-specific engine fitment features for a selected engine platform. The platform-specific engine fitment features may include at least an engine cylinder head pattern corresponding to engine block 110. The lower manifold adapter includes one or more openings configured to align with the intake ports of the cylinder heads or lower manifold, thereby providing airflow passages between the supercharger and the engine intake system. Specifically, the second machine operation may include drilling holes or openings for the selected engine platform and machining a sealing surface, where each hole corresponds to a cylinder head of engine block 110. For example, four holes can be formed for a four-cylinder engine. The second machine operation may also include forming one or more mounting holes in the bottom flange 221 of the lower manifold adapter for securing the adapter to the engine. In some implementations, the mounting holes may be threaded holes having an M8 thread specification, such as M8x1.25 threads. A machining program corresponding to the specific engine platform may be selected and executed during the second machine operation.

The manufacturing method illustrated in FIG. 3 may achieve a manufacturing time of less than 0.5 hours per unit. The reduced manufacturing time may be attributed to the two-step machining workflow with repeatable datums, which simplifies setups and increases repeatability compared with platform-specific machining processes. The fixture-based strategy enables multiple adapters to be machined in one setup, reducing per-platform fixturing and setup time. In some embodiments, the first and second machining processes can be reversed. For example, the top flange can be machined first followed by a process that forms the features on the bottom flange.

Referring to FIGS. 4A-4E, the manufacturing process for the lower manifold adapter of the modular supercharger adapter system 100 is illustrated. FIG. 4A depicts a cast for producing the mold used in the manufacturing process of the lower manifold adapter. FIG. 4B depicts an isometric view of a lower manifold adapter. The lower manifold adapter shown in FIG. 4B includes a generally rectangular body with rounded corners and a raised central portion. The body features recessed areas on the top surface that correspond to the engine intake port configuration. The lower manifold adapter includes mounting provisions at corners for securing the component to adjacent parts of the modular supercharger adapter system 100.

Referring to FIGS. 4C-4E, various views of lower manifold adapters for the modular supercharger adapter system 100 are illustrated. FIG. 4C depicts multiple perspective views of a lower manifold adapter component prior to forming openings in the bottom flange. FIG. 4C includes views showing the adapter from different angles including a front view, a rear view, a bottom view, and an angled perspective view. The adapter features a generally rectangular form with rounded corners. Internal ribbing structures are visible in the rear view, providing structural reinforcement to the lower manifold adapter body.

As further shown in FIG. 4D, two isometric views of a lower manifold adapter positioned within a manufacturing fixture or mold assembly are presented. The lower manifold adapter includes features such as recesses or grooves for securing the adapter to a work surface or machine. For example, the lower manifold adapter is shown seated within a recessed cavity of the fixture, with internal ribbing and contoured surfaces visible. The work surface fixture includes raised corner blocks that may provide alignment and clamping functions during manufacturing or assembly operations.

Referring to FIG. 4E, a top-down orthogonal view of a lower manifold adapter assembly is shown after openings and holes are formed in the bottom flange. This view reveals an internal configuration of the adapter, including multiple openings arranged in a pattern that corresponds to engine intake port locations. The adapter features a rectangular outer perimeter with a gasket sealing surface surrounding the internal openings. The internal structure includes ribbing and support features that provide structural integrity while maintaining airflow passages. Corner mounting points are visible around the perimeter for securing the adapter to adjacent components.

The lower manifold adapter may be manufactured via casting processes with subsequent machining operations. The casting process enables production of complex internal geometries, including the ribbing structures visible in FIGS. 4C-4E, that may be difficult or impossible to achieve using traditional sheet metal fabrication methods.

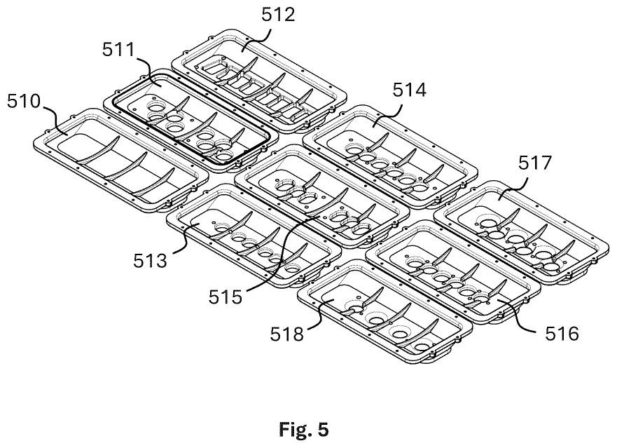

Referring to FIG. 5, a collection of adapter plates configured for various engine platforms is illustrated in an isometric view. The adapter plates are arranged in a grid pattern showing nine different configurations, most of which correspond to a different engine platform. The adapter plates share a standardized outer profile while incorporating different internal port configurations and mounting patterns corresponding to their respective engine platforms.

A blank casting adapter plate 510 represents a base template from which other adapter plates may be derived. The blank casting adapter plate 510 includes a generally rectangular configuration with rounded corners and mounting holes arranged around a perimeter for securing the adapter plate to engine components. The blank casting adapter plate 510 may serve as a starting point for machining platform-specific features, enabling adaptation to engine platforms not represented by the pre-configured adapter plates.

Adapter plate 511 is configured for 5.0L Ford Windsor V8 engines and includes internal port configurations and mounting patterns that correspond to the intake port locations and bolt patterns of the 5.0L Ford Windsor V8 engine platform.

Adapter plate 512 is configured for 5.8L Ford Windsor V8 engine applications and shares the standardized outer profile with the other adapter plates while incorporating internal port configurations specific to the 5.8L Ford Windsor V8 engine platform.

Adapter plate 513 is configured for Nissan VG33 engine platforms and includes internal port configurations and mounting patterns that correspond to the intake port locations and bolt patterns of the Nissan VG33 engine while maintaining the standardized outer profile shared by the other adapter plates.

Adapter plate 514 is configured for Toyota 5VZ-FE engine configurations and includes internal port configurations corresponding to the Toyota 5VZ-FE engine platform while maintaining the standardized outer profile shared by the other adapter plates.

Adapter plate 515 is configured for Ford 3.8L Essex V6 engines and includes internal port configurations and mounting patterns specific to the Ford 3.8L Essex V6 engine platform while maintaining the standardized outer profile shared by the other adapter plates.

Adapter plate 516 is configured for Nissan VQ35DE engine applications and includes internal port configurations and mounting patterns that correspond to the intake port locations and bolt patterns of the Nissan VQ35DE engine while maintaining the standardized outer profile shared by the other adapter plates.

Adapter plate 517 is configured for Honda J series engines and includes internal port configurations corresponding to the Honda J series engine platform while maintaining the standardized outer profile shared by the other adapter plates.

Adapter plate 518 includes internal port configurations and mounting patterns specific to the Ford 2.3L Lima engine platform while maintaining the standardized outer profile shared by the other adapter plates.

The modular lower manifold adapter design provides a benefit in that changing a single adapter blank enables adaptation to a different engine platform with changes made only to the bottom flange and without requiring replacement of other components of the modular supercharger adapter system 100. The standardized outer profile of the bottom flanges of the adapters allows various engine bolt patterns, enabling consistent attachment regardless of the selected engine platform. The different internal opening configurations of the adapters align with the intake port locations of the respective engine platforms, providing airflow paths from the plenum volume 226 to the engine intake ports.

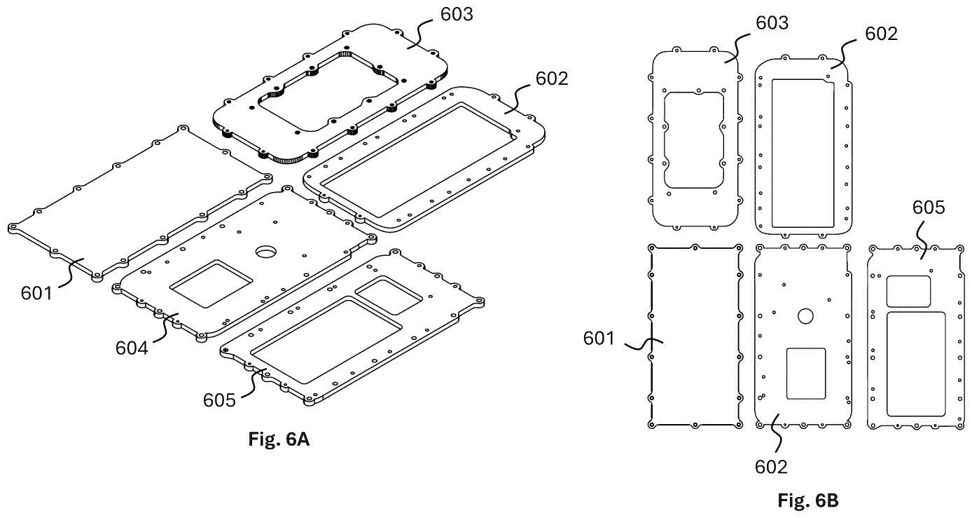

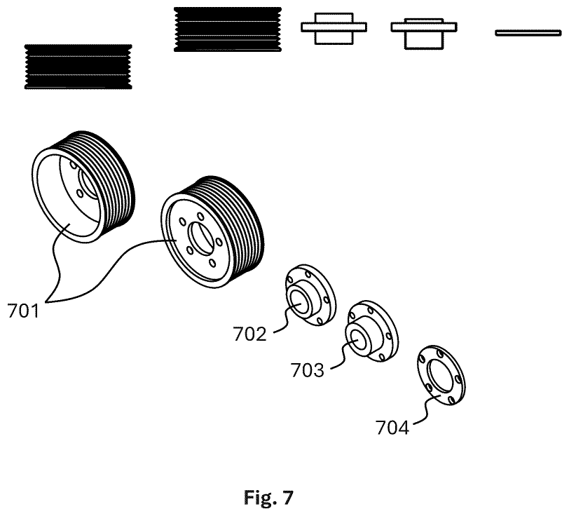

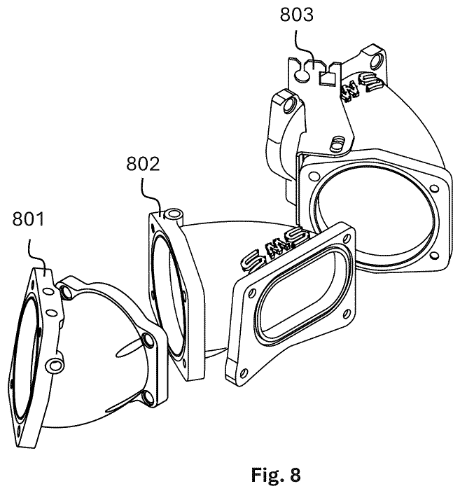

Referring to FIGS. 6A-6B, adapter plates configured for different supercharger models are illustrated in multiple views. FIG. 6A provides an isometric view showing a base adapter plate 601 and multiple interchangeable adapter plates configured for different supercharger models. FIG. 6B provides a top plan view of the same adapter plate configurations. The adapter plates shown in FIGS. 6A-6B are configured to interface between the lower manifold adapter 220 and various supercharger models, enabling compatibility with multiple OEM superchargers using a single modular system.

Adapter plate is a flat interface component that couples to the lower manifold adapter on its bottom attachment interface and to the supercharger on its upper attachment interface. The adapter plate is configured to enable rapid iteration and broad compatibility without revising the casting or re-spinning platform-specific tooling. By forming the plate from flat stock—such as via CNC laser cutting—and fastening it to the lower manifold adapter using a rectangular fastener array, the system standardizes the upper attachment interface while preserving flexibility to support different superchargers, intercoolers, or upper manifolds across programs. This approach stands in contrast to prior systems that either machine the supercharger pad directly into a platform-specific casting/billet manifold or require a unique billet adapter for each engine family, driving cost and lead time with every new fitment.

The rectangular plate-to-casting bolt pattern may be proprietary or conform to an industry-standard rectangular pattern, allowing the plate to be produced, stocked, and updated independently of engine platform selection while maintaining a single, stable interface to the lower manifold adapter. This in turn provides the benefit of supporting new supercharger or intercooler variants by revising only the central areas of the adapter plate geometry, avoiding any change to the lower manifold adapter. The result is a decoupled and streamlined supply chain: lower manifold adapter production and engine-side machining proceed on a common cadence, while adapter plates can be cut on demand for specific upper components or customer applications.

Because the adapter plate is planar and free of protruding airflow features, it preserves a low-profile mounting stack that complements the lower manifold adapter's integrated plenum and below-face airflow path, reducing the need for height-adding spacers that many modular plenum systems require for basic supercharger packaging. When additional volume or tuning is desired, spacers can be added as an optional element between the lower manifold adapter and the plate rather than as a prerequisite for functionality. This arrangement reduces packaging complexity, supports tighter under-hood envelopes, and simplifies calibration by keeping the primary plenum geometry stable in the casting while the plate carries only the attachment pattern and upper-component interface.

Relative to existing adapter solutions, the plate's manufacturing method and interface strategy yield concrete economic and operational advantages. Flat-stock CNC cutting minimizes capital tooling, accelerates prototype-to-production transitions, and enables batch or on-demand runs without the expense and lead time of billet machining or platform-specific cast supercharger pads. The rectangular fastener array consolidates inventory to a small family of common plates rather than proliferating unique upper-interface geometries tied to each engine program, which reduces SKUs, simplifies stocking, and expedites field updates. In aggregate, the adapter plate's decoupled, standardized design shortens development cycles for new upper components while maintaining compatibility across a broad engine portfolio. Numerous adapter plate designs and manufacturing processes are described in further detail below.

The base adapter plate 601 serves as a foundation template from which other adapter plate configurations may be derived. The base adapter plate 601 features a generally rectangular configuration with mounting holes arranged around a perimeter for securing the base adapter plate 601 to the lower manifold adapter 220 or other engine components. The base adapter plate 601 may serve as a starting point for creating adapter plates configured for supercharger models not represented by the pre-configured adapter plates. For example, a central aperture can contain multiple openings configured to couple to each supercharger's discharge conduits and allow compressed air to pass through.

Adapter plate 602 is an example of an adapter plate that is made from base adapter plate 601 using any suitable manufacturing methods, such as laser cutting. Adapter plate 602 includes a central aperture configuration sized and shaped to correspond to an Eaton M112 supercharger port arrangement. The adapter plate 602 features a gasket sealing surface surrounding the central aperture and mounting provisions around the perimeter. The adapter plate 602 is configured for the Eaton M112 supercharger from 2003-2004 Ford Mustang Cobra applications.

Adapter plate 603 includes a central aperture configuration corresponding to the Jaguar TVS1900 and TVS1320 supercharger models. The adapter plate 603 includes mounting features and port configurations that correspond to the inlet and outlet port locations of the Land Rover/Jaguar TVS superchargers, enabling direct attachment of TVS1900 and TVS1320 supercharger units to the modular supercharger adapter system 100.

Adapter plate 604 features a central aperture configuration corresponding to the Eaton M90 supercharger model. The adapter plate 604 includes mounting features and port configurations that correspond to the inlet and outlet port locations of the Eaton M90 supercharger from GM 3.8L V6 applications, enabling attachment of the Eaton M90 supercharger unit to the modular supercharger adapter system 100.

Adapter plate 605 includes a central aperture configuration corresponding to Ford GT500 superchargers from 2007-2013 and Roush 5.0L Ford superchargers. The adapter plate 605may also accommodate Ford Performance 5.0L superchargers. The adapter plate 605 includes mounting features and port configurations that correspond to the inlet and outlet port locations of the Ford GT500 and Roush supercharger models.

Each adapter plate shown in FIGS. 6A-6B shares a standardized outer profile with mounting holes distributed around the perimeter. The standardized outer profile enables the adapter plates to interface with the adapter bolt pattern 225 of the lower manifold adapter 220. The different internal port configurations and mounting patterns of the adapter plates correspond to their respective supercharger models. The adapter plates may be manufactured from aluminum using CNC laser cutting for precision and cost-efficiency.

The manufacturing process for the adapter plates shown in FIGS. 6A-6B may include CNC laser cutting followed by threading performed on a drill press. The CNC laser cutting process cuts the adapter plate profile and aperture configurations from flat aluminum stock. Following the laser cutting operation, threading operations may be performed on a drill press to create threaded holes for fastener attachment. The manufacturing process may reduce manufacturing time to less than 0.5 hours per unit.

In some cases, manufacturing processes may include complete CNC cutting and threading using a 3-axis CNC machine. The 3-axis CNC machine may perform both the cutting and threading operations in a single setup, which may further reduce manufacturing time and labor requirements.

Therefore, the modular adapter plate design provides numerous benefits, including that changing a single adapter plate enables adaptation to a different supercharger model without requiring replacement of other components of the modular supercharger adapter system 100. The standardized outer profile of the adapter plates interfaces with the adapter bolt pattern 225 of the lower manifold adapter 220, enabling consistent attachment regardless of the selected supercharger model. The different internal port configurations of the adapter plates align with the inlet and outlet port locations of the respective supercharger models, providing airflow paths between the supercharger assembly 150 and the plenum volume 226.

Referring to FIG. 7, a modular pulley and hub assembly for the modular supercharger adapter system 100 is illustrated in multiple views. The upper portion of FIG. 7 presents orthogonal views showing individual components in a linear arrangement, while the lower portion provides an isometric exploded view depicting spatial relationships between the components. The modular pulley and hub assembly enables attachment of the supercharger assembly 150 to an accessory drive system of the engine block 110. For example, the hub can be fitted onto the supercharger, and the pulley can be bolted to the hub. One or more spacers can be inserted between the hub and the pulley.

A pulley 701 is shown in FIG. 7 with a multi-groove configuration for engagement with a serpentine belt. The pulley 701 can be manufactured from any suitable material, such as 6061 aluminum. The multi-groove configuration of the pulley 701 corresponds to serpentine belt profiles used in automotive accessory drive systems. The pulley 701 may be mounted in a front-facing orientation or a rear-facing orientation to accommodate different belt spacing requirements.

With continued reference to FIG. 7, an M90/M112/M122 modular hub 702 is provided. The M90/M112/M122 modular hub 702 can be manufactured from suitable stainless steel. The M90/M112/M122 modular hub 702 is configured to couple the pulley 701 to supercharger input shafts of Eaton M90, Eaton M112, and Eaton M122 supercharger models. The M90/M112/M122 modular hub 702 features a bolt circle pattern with multiple fastener locations for securing the pulley 701 to the M90/M112/M122 modular hub 702. The dimensional annotations in FIG. 7 indicate a bolt circle pattern designated as 15× diameter 6.3×31.

A TVS modular hub 703 can also be manufactured from suitable stainless steel. The TVS modular hub 703 provides an interchangeable hub configuration for TVS supercharger models, including Land Rover/Jaguar TVS 1900 and TVS 1320 superchargers. The dimensional annotations in FIG. 7 indicate a consistent outer diameter of 28.45 mm for both the M90/M112/M122 modular hub 702 and the TVS modular hub 703. The interchangeability of the M90/M112/M122 modular hub 702 and the TVS modular hub 703 enables the pulley 701 to be used with different supercharger models by selecting the appropriate hub configuration.

A pulley spacer 704 is configured to adjust spacing between the pulley 701 and the respective hub to accommodate different belt configurations. In some cases, multiple pulley spacers 704 may be stacked to achieve a desired belt spacing dimension.

The modular pulley and hub assembly shown in FIG. 7 provides a benefit in that a single pulley design may accommodate multiple belt spacing configurations. The pulley 701 may be bolted in multiple orientations to accommodate different belt spacing requirements. By mounting the pulley 701 in a front-facing orientation or a rear-facing orientation, different belt line positions may be achieved without requiring different pulley designs. The pulley spacer 704 provides additional adjustment capability, enabling fine-tuning of belt spacing to match the accessory drive configuration of the engine block 110.

The modular design of the pulley and hub assembly enables compatibility with multiple supercharger models using interchangeable hub components. By selecting the M90/M112/M122 modular hub 702, the pulley 701 may be attached to Eaton M90, M112, or M122 supercharger models. By selecting the TVS modular hub 703, the pulley 701 may be attached to Land Rover/Jaguar TVS supercharger models. The interchangeable hub design reduces the number of unique pulley components that may be stocked, as a single pulley 701 may be used across multiple supercharger platforms by pairing the pulley 701 with the appropriate hub configuration.

FIG. 8 illustrates an isometric exploded view of throttle body adapters configured for different supercharger models in the modular supercharger adapter system. The figure presents three throttle body adapter configurations arranged to show their spatial relationships and individual configurations. The throttle body adapters can be placed between the supercharger and the throttle body. They are configured to fit the original throttle body found on the engine being retrofitted. In some embodiments, the throttle body adapters can be formed of a composite material, such as PA6-20% carbon fiber which provides the benefits of reducing thermal transfer into the intake charge, which in turn increases engine efficiency. They also provide the benefit of having less weight then other alternatives such as metal. In some embodiments, the throttle body adapters can be formed using 3D printing which allows for greater design flexibility in production workflows.

A Jaguar TVS1900 and TVS1320 throttle body adapter 801 features a circular flange configuration with mounting holes arranged around the perimeter for securing the adapter to adjacent components. The circular profile corresponds to the outlet port configuration of the Jaguar TVS1900 and TVS1320 supercharger models.

An Eaton M112 throttle body adapter 802 includes a body portion with internal passages and a mounting flange. The Eaton M112 throttle body adapter 802 features a rectangular port configuration on one side that corresponds to the outlet port arrangement of the Eaton M112 supercharger from 2003-2004 Ford Mustang Cobra applications. The adapter body includes structural features and mounting provisions for attachment to adjacent components.

A Ford GT500 throttle body adapter 803 includes a curved body portion with mounting features and connection points. The Ford GT500 throttle body adapter 803 is configured for compatibility with Ford GT500 superchargers from 2007-2013 applications.

The throttle body adapters depicted in FIG. 8 can be manufactured from carbon fiber-reinforced nylon with brass threaded inserts, providing lightweight construction and reduced heat soak characteristics. The throttle body adapters serve as interfaces between the supercharger outlets and throttle bodies or intake ducting, with each adapter configuration corresponding to the specific port arrangements of the respective supercharger models.

According to an aspect of the present disclosure, a modular supercharger adapter system for automotive engine platforms is provided. The system includes a unibody lower manifold adapter configured to interface between a supercharger assembly and an engine component. The lower manifold adapter includes a flange portion machinable to fit a plurality of different OEM lower manifolds. The system further includes an adapter plate manufactured from aluminum and configured to mount the supercharger assembly to the lower manifold adapter. The adapter plate includes mounting features arranged to accommodate multiple different supercharger models through implementing various openings formed through the adapter plate. The system also includes a modular pulley and hub assembly configured to transfer rotational power from an engine crankshaft to a supercharger input shaft. The modular pulley and hub assembly includes a pulley manufactured from aluminum, a hub manufactured from stainless steel, and at least one spacer. The pulley is configured to be mounted in multiple orientations to accommodate different belt spacing requirements. The hub is interchangeable to accommodate different supercharger shaft configurations. The spacer is configured to adapt the assembly to different belt configurations.

According to some aspects of the present disclosure, the modular supercharger adapter system may include one or more of the following features. The lower manifold adapter may be manufactured by casting or by cutting from a flat sheet with parts nested together for material efficiency. The adapter plate may be manufactured using computer numerical control (“CNC”) laser cutting. The adapter plate may also include threaded mounting holes formed by threading performed on a drill press. The adapter plate may include threaded mounting holes formed by complete CNC cutting and threading using a 3-axis NC machine. The system may further include a throttle body adapter manufactured from carbon fiber-reinforced nylon with brass threaded inserts. The throttle body adapter may be manufactured via 3D printing with water-soluble supports. The brass threaded inserts may be melted into place after curing of the throttle body adapter. The different supercharger models may include an Eaton M90 supercharger, an Eaton M112 supercharger, a Ford GT500 supercharger, a Roush 5.0L Ford supercharger, a Ford Performance 5.0L supercharger, a Land Rover TVS 1900 supercharger, a Land Rover TVS 1320 supercharger, and a Jaguar M112 supercharger. The engine component may be associated with an engine platform selected from a Small Block Ford V8 engine, a General Motors LS engine, a General Motors LT engine, a Ford 4.0L V6 engine, a Ford 3.0L V6 engine, a Nissan VQ engine, and other suitable engine platforms. The hub may include a first hub configuration for M90, M112, and M122 superchargers and a second hub configuration for TVS superchargers.

According to another aspect of the present disclosure, an adapter plate for a modular supercharger retrofit system is provided. The adapter plate can include a base plate portion and an interchangeable plate portion. The base plate portion can have a generally rectangular configuration with rounded or square corners and manufactured from aluminum using CNC laser cutting. The adapter plate includes mounting holes arranged around a perimeter for securing the adapter plate to a lower manifold adapter. The interchangeable adapter plate section is configured to interface with a specific supercharger model. The interchangeable adapter plate section includes a central aperture sized and shaped to correspond to a port configuration of the specific supercharger model. The interchangeable adapter plate section can include a gasket sealing surface surrounding the central aperture. The adapter plate is configured such that replacement of the interchangeable adapter plate section enables compatibility with a different supercharger model while retaining the base plate portion.

According to other aspects of the present disclosure, the adapter plate may include one or more of the following features. The base plate portion and the interchangeable adapter plate section may be configured to be cut from a single flat sheet in a nested arrangement for material efficiency. The plurality of mounting holes may include threaded holes having an M6 or M8 thread specification, or any other suitable thread specifications. The interchangeable adapter plate section may be selected from a plate adapter section suitable for a specific supercharger, such as an Eaton M112 adapter plate section, a Jaguar TVS1900 and TVS1320 adapter plate section, an Eaton M90 adapter plate section, and a Ford GT500 and Roush 5.0L adapter plate section.

According to another aspect of the present disclosure, a modular pulley and hub assembly for a supercharger retrofit system is provided. The assembly includes a pulley that can be manufactured from aluminum, such as 6061 aluminum. The pulley has a multi-groove configuration for engagement with a belt. The pulley is configured to be mounted in a front-facing orientation or a rear-facing orientation to accommodate different belt spacing requirements. The assembly further includes a hub that can be manufactured from stainless steel. The hub is configured to couple the pulley to a supercharger input shaft. The hub is interchangeable between a first hub configuration for superchargers such as Eaton M90, M112, and M122 superchargers and a second hub configuration for superchargers such as TVS superchargers. The assembly can also include at least one pulley spacer manufactured from aluminum, such as 6061 aluminum. The pulley spacer is configured to adjust spacing between the pulley and the hub to accommodate different belt configurations.

According to other aspects of the present disclosure, the modular pulley and hub assembly may include one or more of the following features. The hub may be manufactured from 309 stainless steel. The pulley spacer may have a suitable thickness, such as between about 2-5 millimeters. The pulley may include a bolt circle pattern with a plurality of fastener locations for securing the pulley to the hub.

According to another aspect of the present disclosure, a throttle body adapter for a supercharger retrofit system is provided. The throttle body adapter includes a body manufactured from carbon fiber-reinforced nylon. The body has a first end configured to interface with a supercharger outlet and a second end configured to interface with a throttle body or intake ducting. The throttle body adapter further includes a plurality of brass threaded inserts embedded in the body. The brass threaded inserts provide mounting points for securing the throttle body adapter to adjacent components. The throttle body adapter is manufactured via 3D printing with water-soluble supports, with the brass threaded inserts melted into place after curing.

According to other aspects of the present disclosure, the throttle body adapter may include one or more of the following features. The throttle body adapter may be configured for a specific supercharger model selected from a Jaguar TVS1900 supercharger, a Jaguar TVS1320 supercharger, an Eaton M112 supercharger, a Ford GT500 supercharger, and a Roush 5.0L Ford supercharger. The body may include a rectangular flange portion with mounting holes at corners and a circular or oval throttle body opening.

According to another aspect of the present disclosure, a method of retrofitting a supercharger onto an automotive engine is provided. The method includes selecting a lower manifold adapter design configured to interface with a lower intake manifold or intake ports of the cylinder head of the engine. The method also includes using the design to machine a flange portion of the lower manifold adapter to fit the lower intake manifold or cylinder head. The method further includes selecting an interchangeable adapter plate section corresponding to a supercharger model to be installed. The method also includes forming an adapter plate by forming the selected interchangeable adapter plate section in the base plate portion. The method also includes mounting the adapter plate to the lower manifold adapter. The method includes configuring a modular pulley and hub assembly by selecting a hub corresponding to the supercharger model and mounting a pulley in an orientation and with spacers selected to achieve a desired belt spacing. The method further includes installing the supercharger onto the adapter plate and connecting the modular pulley and hub assembly to the supercharger input shaft.

According to other aspects of the present disclosure, the method may include one or more of the following features. The method may further include installing a throttle body adapter manufactured from carbon fiber-reinforced nylon between the supercharger outlet and a throttle body. The engine may be selected from a Small Block Ford V8 engine, a General Motors LS engine, a General Motors LT engine, a Ford V6 engine, and a Nissan VQ engine. The supercharger model may be selected from an Eaton M90, an Eaton M112, a Ford GT500 supercharger, a Roush 5.0L Ford supercharger, a Land Rover TVS 1900, a Land Rover TVS 1320, and a Jaguar M112.

A modular supercharger adapter system for automotive engine platforms includes a lower manifold adapter and an adapter plate. The lower manifold adapter is positioned entirely between a supercharger assembly and an engine component. The lower manifold adapter includes an engine-side flange machined to form platform-specific engine fitment features for a selected engine platform; a supercharger-side flange machined to form platform-specific supercharger fitment features for a selected supercharger; and a cast body defining a plenum volume contained within the cast body and between the engine-side flange and the supercharger-side flange, wherein the cast body is common across a plurality of engine platforms. The adapter plate is configured to mount the supercharger assembly to the lower manifold adapter. The adapter plate includes one or more fastener openings arranged in a rectangular array and a central aperture for allowing air to pass through the supercharger assembly into the plenum volume.

The engine-side flange includes a generally rectangular machinable surface configured to accept one or more different engine bolt patterns. The platform-specific engine fitment features include at least an engine bolt pattern and a sealing surface. The adapter plate provides an attachment interface for at least one of the supercharger assembly, an intercooler, or an upper manifold. The adapter plate is manufactured from aluminum using a laser cutting process. The lower manifold adapter is formed of cast aluminum. The lower manifold adapter can be positioned entirely above the engine component. The adapter plate is positioned entirely above the lower manifold adapter. The supercharger assembly is positioned entirely above the adapter plate. The height of the lower manifold adapter measured between the engine-side flange and the supercharger-side flange is between about 40 mm and 70 mm.

A modular supercharger adapter system for automotive engine platforms includes a lower manifold adapter positioned entirely above an engine component and entirely below a supercharger assembly. The lower manifold adapter includes an engine-side flange machined to form platform-specific engine fitment features for a selected engine platform; a supercharger-side flange machined to form platform-specific supercharger fitment features for a selected supercharger, wherein a lateral surface area of the supercharger-side flange is greater than a lateral surface area of the engine-side flange; and a cast body defining a plenum volume contained within the cast body and between the engine-side flange and the supercharger-side flange, wherein the cast body comprises at least one trapezoidal cross-sectional area. The modular supercharger adapter system also includes an adapter plate positioned entirely above the lower manifold adapter and configured to mount the supercharger assembly to the lower manifold adapter, wherein the adapter plate includes one or more fastener openings arranged in a rectangular array and a central aperture for allowing air to pass through the supercharger assembly into the plenum volume.

In some embodiments, the cast body is common across a plurality of engine platforms. The platform-specific engine fitment features include one or more openings, and wherein each opening of the plurality of openings is aligned with a cylinder head of the engine component. In some embodiments, the lower manifold adapter comprises cast aluminum. The supercharger assembly can be positioned entirely above the adapter plate.

A method of manufacturing a multi-fit supercharger manifold assembly includes forming a lower manifold adapter which includes providing a lower manifold adapter blank comprising a cast body that defines a plenum volume contained within the cast body, the lower manifold adapter blank further comprising a supercharger-side machinable interface region and an engine-side machinable interface region. The method also includes performing a first machining operation on the engine-side interface region to form a functional datum feature. The method further includes positioning the lower manifold blank on a fixture using at least the functional datum feature. The method also includes performing a second machining operation on the engine-side interface region to form a bottom flange, wherein the bottom flange comprises platform-specific engine fitment features, the platform-specific engine fitment features including at least a plurality of openings that align with a plurality of intake ports of a cylinder head of an engine component. The method also includes providing a supercharger adapter plate, wherein the supercharger adapter plate comprises a fastener pattern including a plurality of fastener openings. The method also includes attaching the supercharger adapter plate to the lower manifold adapter using the plurality of fastener openings.

The method also includes attaching a supercharger assembly to a top surface of the supercharger adapter plate, wherein lower manifold adapter is attached to the supercharger adapter plate on a bottom surface of the supercharger adapter plate that is opposite to the top surface.

The supercharger assembly is entirely above the supercharger adapter plate after the supercharger assembly is attached to the supercharger adapter plate.

The method further includes attaching the bottom flange of the lower manifold adapter to an engine component using the platform-specific engine fitment features, wherein each opening of the plurality of openings aligns with an intake port of a cylinder head.

The method also includes providing a lower manifold adapter blank comprises forming the cast body by an aluminum casting process.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 wt. %” is intended to mean “about 40 wt. %”.

A number of implementations have been described. Nevertheless, it will be understood that various modifications may be made without departing from the spirit and scope of the disclosure. Accordingly, other implementations are within the scope of the following claims.

1. A modular supercharger adapter system for automotive engine platforms, comprising:
a lower manifold adapter positioned entirely between a supercharger assembly and an engine component, the lower manifold adapter comprising:
an engine-side flange machined to form platform-specific engine fitment features for a selected engine platform;
a supercharger-side flange machined to form platform-specific supercharger fitment features for a selected supercharger; and
a cast body defining a plenum volume contained within the cast body and between the engine-side flange and the supercharger-side flange, wherein the cast body is common across a plurality of engine platforms; and
an adapter plate configured to mount the supercharger assembly to the lower manifold adapter, wherein the adapter plate comprises a plurality of fastener openings arranged in a rectangular array and a central aperture for allowing air to pass through the supercharger assembly into the plenum volume.

2. The modular supercharger adapter system of claim 1, wherein the engine-side flange comprises a generally rectangular machinable surface configured to accept a plurality of different engine bolt patterns.

3. The modular supercharger adapter system of claim 2, wherein the platform-specific engine fitment features comprise at least an engine bolt pattern and a sealing surface.

4. The modular supercharger adapter system of claim 1, wherein the adapter plate provides an attachment interface for at least one of the supercharger assembly, an intercooler, or an upper manifold.

5. The modular supercharger adapter system of claim 1, wherein the adapter plate is manufactured from aluminum using a laser cutting process.

6. The modular supercharger adapter system of claim 1, wherein the lower manifold adapter comprises cast aluminum.

7. The modular supercharger adapter system of claim 1, wherein the lower manifold adapter is positioned entirely above the engine component.

8. The modular supercharger adapter system of claim 7, wherein the adapter plate is positioned entirely above the lower manifold adapter.

9. The modular supercharger adapter system of claim 8, wherein the supercharger assembly is positioned entirely above the adapter plate.

10. The modular supercharger adapter system of claim 1, wherein the height of the lower manifold adapter measured between the engine-side flange and the supercharger-side flange is between about 40 mm and 70 mm.

11. A modular supercharger adapter system for automotive engine platforms, comprising:
a lower manifold adapter positioned entirely above an engine component and entirely below a supercharger assembly, the lower manifold adapter comprising:
an engine-side flange machined to form platform-specific engine fitment features for a selected engine platform;
a supercharger-side flange machined to form platform-specific supercharger fitment features for a selected supercharger, wherein a lateral surface area of the supercharger-side flange is greater than a lateral surface area of the engine-side flange; and
a cast body defining a plenum volume contained within the cast body and between the engine-side flange and the supercharger-side flange, wherein the cast body comprises at least one trapezoidal cross-sectional area; and
an adapter plate positioned entirely above the lower manifold adapter and configured to mount the supercharger assembly to the lower manifold adapter, wherein the adapter plate comprises a plurality of fastener openings arranged in a rectangular array and a central aperture for allowing air to pass through the supercharger assembly into the plenum volume.

12. The modular supercharger adapter system of claim 11, wherein the cast body is common across a plurality of engine platforms.

13. The modular supercharger adapter system of claim 11, wherein the platform-specific engine fitment features comprise a plurality of openings, and wherein each opening of the plurality of openings is aligned with a cylinder head of the engine component.

14. The modular supercharger adapter system of claim 11, wherein the lower manifold adapter comprises cast aluminum.

15. The modular supercharger adapter system of claim 11, wherein the supercharger assembly is positioned entirely above the adapter plate.

16. A method of manufacturing a multi-fit supercharger manifold assembly, comprising:
forming a lower manifold adapter, comprising:
providing a lower manifold adapter blank comprising a cast body that defines a plenum volume contained within the cast body, the lower manifold adapter blank further comprising a supercharger-side machinable interface region and an engine-side machinable interface region;
performing a first machining operation on the engine-side interface region to form a functional datum feature;
positioning the lower manifold adapter blank on a fixture using at least the functional datum feature; and
performing a second machining operation on the engine-side interface region to form a bottom flange, wherein the bottom flange comprises platform-specific engine fitment features, the platform-specific engine fitment features including at least a plurality of openings that align with a plurality of intake ports of a cylinder head of an engine component;
providing a supercharger adapter plate, wherein the supercharger adapter plate comprises a fastener pattern including a plurality of fastener openings; and
attaching the supercharger adapter plate to the lower manifold adapter using the plurality of fastener openings.

17. The method of claim 16, further comprising attaching a supercharger assembly to a top surface of the supercharger adapter plate, wherein the lower manifold adapter is attached to the supercharger adapter plate on a bottom surface of the supercharger adapter plate that is opposite to the top surface.

18. The method of claim 17, wherein the supercharger assembly is entirely above the supercharger adapter plate after the supercharger assembly is attached to the supercharger adapter plate.

19. The method of claim 16, further comprising attaching the bottom flange of the lower manifold adapter to an engine component using the platform-specific engine fitment features, wherein each opening of the plurality of openings aligns with an intake port of the plurality of intake ports.

20. The method of claim 16, wherein providing the lower manifold adapter blank comprises forming the cast body by an aluminum casting process.
